(19) United States
(12) Patent Application Publication
(10) Pub. No.: US 2016/0050718 A1
(43) Pub. Date: Feb. 18, 2016

(54) HEATED CAR COVER

(71) Applicant: Alexander Follman, Brooklyn, NY (US)

(72) Inventor: Alexander Follman, Brooklyn, NY (US)

(21) Appl. No.: 14/829,476

(22) Filed: Aug. 18, 2015

Related U.S. Application Data
(60) Provisional application No. 62/038,800, filed on Aug. 18, 2014.

(51) Int. Cl. H05B 3/34; B63B 17/02; B60J 11/04; H05B 3/00

(52) U.S. Cl. CPC H05B 3/342; H05B 3/0014; B63B 17/02; B60J 11/04

(57) ABSTRACT

A cover comprised of an integrated heating element sandwiched between a top layer and a bottom layer that prevent frost, snow and ice from building up on a vehicle, boat, grill, patio set, construction site or roof top for a shed, garage or hut during inclement weather.

### CLAIM OF PRIORITY

This patent application claims priority under 35 USC 119 (e) (1) from U.S. Provisional Patent Application Ser. No. 62/038,800 filed Aug. 18, 2014, of common inventorship herewith entitled, “Heated Car Cover,” which is incorporated herein by reference as though the same were set forth in its entirety.

### FIELD OF THE INVENTION

The present invention pertains to the field of vehicular accessories, and more specifically to the field of heated car covers.

### BACKGROUND OF THE INVENTION

The prior art has put forth several designs for heated car covers. Among these are:

U.S. Pat. No. 6,779,827 to Garry E. Clark describes an automobile cover apparatus and system. The automobile cover generally includes a main cover body having a hood end, a trunk end, an upper surface and a lower surface, connectors located on the hood end and the trunk end, trunk cords connected to the connectors on the trunk end, a trunk anchor connected to the trunk cords on ends of the trunk cords opposite the ends connected to the connectors, hood cords connected to the connectors on the hood end and a hood connection device connected to each of the hood cords opposite the ends connected to the connectors. The cover is combinable with a winder for a automobile cover kit.

U.S. Pat. No. 2,666,840 to Ernest J Poirier describes a vehicle cover comprising a sheet of pliable material having a longitudinal central strip adapted to cover a vehicle top surface from its rear to its front bumper and including side panels having one edge of each secured to an edge of the central strip intermediate its ends. Transverse flexible stays are embedded in the central strip and extend across substantially the entire width thereof as means for securing the central strip to the front and rear bumpers. Flexible stays are resiliently adjustable means for securing the side panels to the sides of a vehicle at spaced points there along. Electrical resistance heaters are embedded in said cover for supplying current to said heaters.

U.S. Pat. No. 2,201,984 to Clark Augustus L describes a novel heated automobile blanket to keep the radiator of an automobile from freezing when it is standing in a cold garage or exposed to outdoor weather. A means is included for heating the blanket and for supporting the blanket adjacent to said supporting means. Entirely covering an automobile, the blanket consists of an outer fabric member, an inner fabric member. Said members are spaced apart by pieces of felt which measure approximately one inch in thickness. The inner fabric member has a multiplicity of openings, approximately one inch in diameter and spaced approximately two feet apart to aid in circulating heated air. In front, the blanket is supported in a substantially spaced relation to the inner blanket by a foldable frame. An open space is provided between the outer blanket and inner blanket by reason of the distribution of the spacing felt blocks. The heated air is generated by a heater which may be a gas, oil or electric stove. This heated air circulates from a chamber area into the space between the blankets. The chamber is formed by reason of the supporting frame which holds the outer blanket away from the heater and also substantially away from the inner blanket.

None of these prior art references describe the present invention.

### SUMMARY OF THE INVENTION

It is an object of the present invention to provide a vehicle cover comprised of integrated heating elements that prevent frost, snow and ice from building up on the vehicle when the automobile is parked during inclement weather.

It is a further object of the present invention to provide a heated cover suitable for use on boats, grills, patio sets, constructions sites and roof tops for sheds, garages and huts.

### BRIEF DESCRIPTION OF THE DRAWINGS

FIG. 1 is an illustrative prototypical diagonal front view showing the present invention covering a vehicle.

FIG. 2 is an illustrative prototypical diagonal back view showing the present invention covering a vehicle.

FIG. 3 is an illustrative close up side view of a section of the present invention showing a heat coil between top and bottom material layers, the top layer being a water resistant and heat absorbing material to melt frozen accumulation and the bottom layer being a soft, heat resistant material to protect the car's surface.

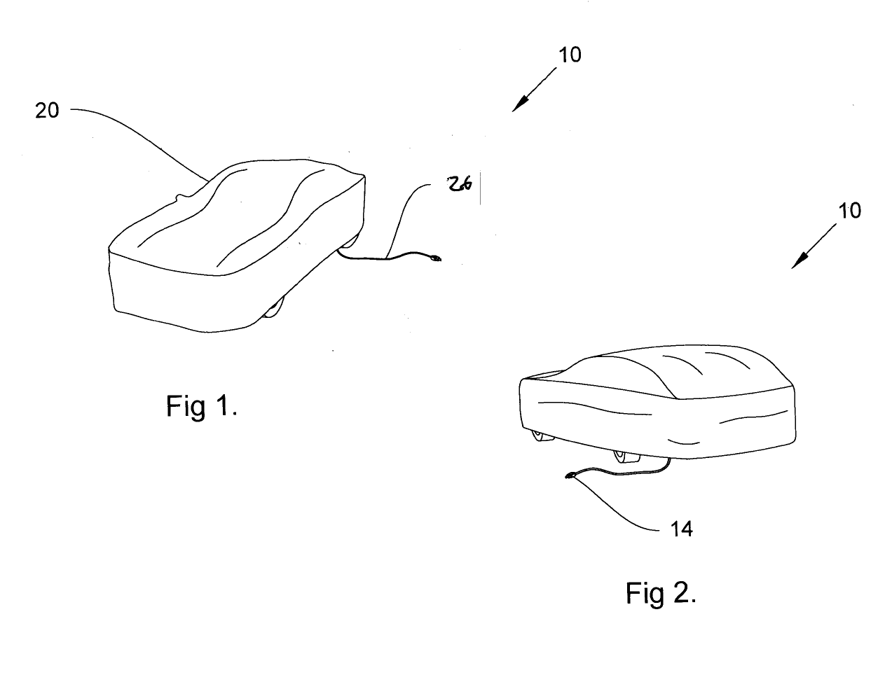

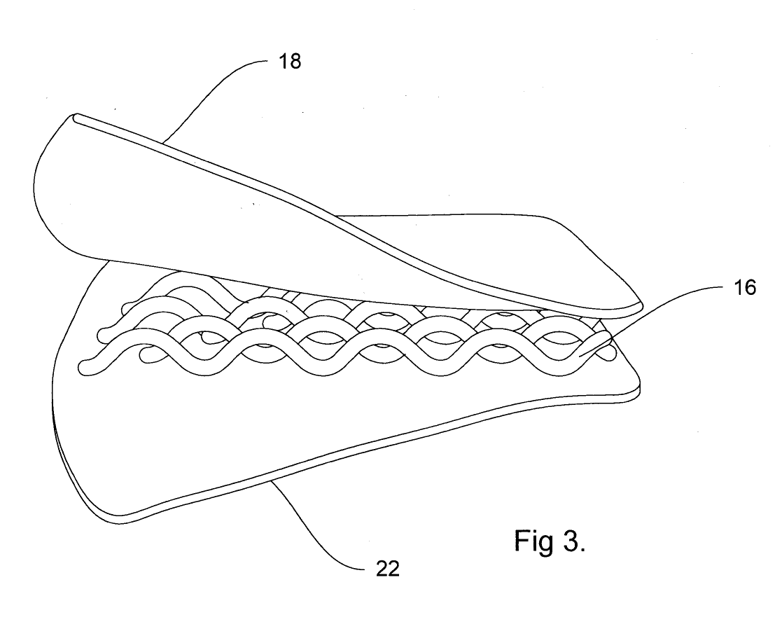

### DETAILED DESCRIPTION OF THE INVENTION

Millions of people climb into their automobiles everyday and head off for a day of work, school, or recreation. Whether a busy executive traveling to an important business luncheon, a homemaker dropping the kids off at a school dance, or a professional delivery man making his rounds, automobiles provide consumers a simple and efficient means of traveling from one destination to the next destination. During winter months, driving one's car usually involves first scraping a vehicle's windshield, windows and exterior body of accumulated frost, ice or snow. This task is particularly common for motorists who live in apartments, condominiums, mobile homes or houses which lack a covered garage, carport or similar sheltered area in which to park their vehicle. Parking cars in open air, even for a few hours, results in the vehicles being covered in a thick blanket of ice or snow. Cleaning vehicles of this debris is a difficult and time consuming task that requires drivers to stand in frigid air as they attempt to remove a snowy buildup. Manually scraping icy residue from vehicles often results in drivers becoming wet, cold and disheveled. Failing to remove snow on a vehicle's hood, roof and trunk prior to driving results in the debris flying off the top of the car on to coming traffic, creating serious safety hazards.

The present invention, hereinafter referred to as the Heated Car Cover, is a vehicle cover comprised of integrated heating elements that prevent frost, snow and ice from building up on the vehicle when the automobile is parked during inclement weather. Please refer to the Figures. The Heated Car Cover 10 comprises internally contained heating elements configured specifically to remove snow and ice from the top of the car. Produced in a range of sizes to accommodate the various makes and models of cars, SUVs and trucks, the Heated Car Cover is manufactured of weather resistant materials such as canvas or nylon. The underside 22 of this covering is lined with a soft, scratch and heat resistant material. A stretchy elastic banding 24 runs along the perimeter of the bottom of the present invention, gently hugging the vehicle under its carriage to provide a strong, custom like fit.

The most notable aspect of the Heated Car Cover and what sets this protective covering apart from other vehicle covers is an internally contained, insulated heating element 16. Manufactured of heavy gauge wire or metal rods, this heating element 16 is sandwiched between two layers of covering. The top layer 20 is a water resistant, heat absorbing material to melt frozen accumulation and the bottom layer 22 is a heat resistant material to protect the car's surface. Similar in function to an electric blanket, this heating element 16 runs in a looped configuration which traverses the length and width of the covering and heats the entire covering. Once activated, the temperature of the insulated heating element quickly rises, warms the surface of the covering and efficiently melts accumulated ice or snow. The Heated Car Cover 10 operates on a rechargeable battery source that is pluggable into a standard power outlet for charging. Power cord 26 supplies power to the heating coil 16. The present invention product is produced in various colors to appeal to individual tastes or to match vehicle color.

The Heated Car Cover provides owners and operators of motor vehicles a simple and efficient means of protecting their cars from exposure to the elements, particularly during the winter months. Preventing frost, snow, and ice from accumulating on the exterior of the automobile, using the Heated Car Cover spares a motorist a time consuming hassle of scraping this frozen precipitation from their car before embarking on a road trip. The present invention also prevents damaging scratches that occur when using scrapers and shovels to remove winter detritus from delicate vehicle surfaces. The Heated Car Cover is effortlessly applied, secured, and removed. Durably constructed of quality materials, the Heated Car Cover will withstand season after season of continual use.

The heated cover of the present invention is also suitable for use on boats, grills, patio sets, constructions sites and roof tops for sheds, garages and huts.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A vehicle cover comprised of an integrated heating element that prevents frost, snow and ice from building up on a vehicle when the vehicle is parked during inclement weather, comprising: a heating element sandwiched between a top layer of covering and a bottom layer of covering, wherein the heating element comprises heavy gauge wire or metal rods.

2. The vehicle cover of claim 1, wherein the top layer is a water resistant, heat absorbing material to melt frozen accumulation

3. The vehicle cover of claim 1, wherein the bottom layer is a soft, scratch and heat resistant material to protect the car's surface.

4. The vehicle cover of claim 2, wherein the bottom layer is a soft, scratch and heat resistant material to protect the car's surface.

5. The vehicle cover of claim 1, further comprising a stretchy elastic banding running along the perimeter of the bottom of the cover to secure the cover on the vehicle.

6. The vehicle cover of claim 4, further comprising a stretchy elastic banding running along the perimeter of the bottom of the cover to secure the cover on the vehicle.

7. The vehicle cover of claim 1, wherein the heating element runs in a looped configuration which traverses the length and width of the covering and heats the entire covering.

8. The vehicle cover of claim 4, wherein the heating element runs in a looped configuration which traverses the length and width of the covering and heats the entire covering.

9. The vehicle cover of claim 1, further comprising a power cord capable of supplying power to the heating element.

10. The vehicle cover of claim 4, further comprising a power cord capable of supplying power to the heating element.

11. The vehicle cover of claim 1, wherein power is supplied by a rechargeable battery source that is pluggable into a standard power outlet for charging.

12. The vehicle cover of claim 4, wherein power is supplied by a rechargeable battery source that is pluggable into a standard power outlet for charging.

13. The vehicle cover of claim 1, produced in one of various colors to appeal to individual tastes or to match vehicle color.

14. The vehicle cove of claim 1, produced in a range of sizes to accommodate the various makes and models of cars, SUVs and trucks.

15. The vehicle cover of claim 1, wherein the top layer is canvas or nylon.

16. A heated cover suitable for use on boats, grills, patio sets, constructions sites and roof tops for sheds, garages and huts comprised of an integrated heating element that prevents the build up of frost, snow and ice during inclement weather, wherein the heating element comprises heavy gauge wire or metal rods, and the heating element is sandwiched between a top layer of covering and a bottom layer of covering.
